(19) United States
(12) Patent Application Publication
(10) Pub. No.: US 2026/0302025 A1
(43) Pub. Date: Oct. 1, 2026

(54) COIL COMPONENT

(71) Applicant: TDK Corporation, Tokyo (JP)

(72) Inventors: Yuiko HIROSE, Tokyo (JP); Mitsunori HIRAOKA, Tokyo (JP); Hitoshi OZAWA, Tokyo (JP); Hong YAN, Tokyo (JP)

(73) Assignee: TDK Corporation, Tokyo (JP)

(21) Appl. No.: 19/577,978

(22) Filed: Mar. 25, 2026

(30) Foreign Application Priority Data
Mar. 27, 2025 (JP) 2025-053943

(51) Int. Cl. H01F 5/06; H01F 5/04; H01F 17/02

(52) U.S. Cl. CPC H01F 5/06; H01F 5/04; H01F 17/02

(57) ABSTRACT

A coil component includes: an element body formed by laminating insulating layers; a coil disposed inside the element body; and a terminal electrode connected to the coil. The element body includes a first main surface forming a mounting surface, a second main surface facing the first main surface in a first direction, a pair of side surfaces adjacent to the first main surface and the second main surface and extending in a second direction perpendicular to the first direction, and a pair of end surfaces adjacent to the first main surface and the second main surface and extending in a third direction perpendicular to the first direction. The first main surface has an area less than an area of the second main surface.

### TECHNICAL FIELD

The present disclosure relates to a coil component. This application claims priority based on Japanese Patent Application No. 2025-053943 filed on Mar. 27, 2025, the entire contents of which are incorporated herein by reference.

### BACKGROUND

### SUMMARY

Japanese Unexamined Patent Publication No. 2014-232815 discloses a coil component that includes an insulator made of resin, a coil-shaped inner conductor provided inside the insulator, and an external electrode electrically connected to the inner conductor.

A coil component according to an aspect of the present disclosure includes an element body formed by laminating insulating layers, a coil disposed inside the element body, and a terminal electrode connected to the coil. The element body includes a first main surface forming a mounting surface, a second main surface facing the first main surface in a first direction, a pair of side surfaces adjacent to the first main surface and the second main surface and extending in a second direction perpendicular to the first direction, and a pair of end surfaces adjacent to the first main surface and the second main surface and extending in a third direction perpendicular to the first direction. The first main surface has an area less than an area of the second main surface.

### BRIEF DESCRIPTION OF THE DRAWINGS

FIG. 1 is a perspective view of a coil component according to an embodiment.

FIG. 2 is a diagram of the coil component illustrated in FIG. 1 as viewed from an end surface side.

FIG. 3 is a diagram of the coil component illustrated in FIG. 1 as viewed from a side surface side.

FIG. 4 is a diagram of the coil component illustrated in FIG. 1 as viewed from a mounting surface side.

FIG. 5 is a photograph of a coil component according to an example as viewed from the side surface side.

### DETAILED DESCRIPTION

When mounting the above coil component on a mounting substrate and sealing it with molding resin, the molding resin may not be filled between the coil component and the mounting substrate.

An object of one aspect of the present disclosure is to provide a coil component that is capable of improving the fillability of molding resin.

A coil component according to an aspect of the present disclosure includes an element body formed by laminating insulating layers, a coil disposed inside the element body, and a terminal electrode connected to the coil. The element body includes a first main surface forming a mounting surface, a second main surface facing the first main surface in a first direction, a pair of side surfaces adjacent to the first main surface and the second main surface and extending in a second direction perpendicular to the first direction, and a pair of end surfaces adjacent to the first main surface and the second main surface and extending in a third direction perpendicular to the first direction. The first main surface has an area less than an area of the second main surface.

In the above coil component, the area of the first main surface forming the mounting surface is less than the area of the second main surface facing the first main surface. Accordingly, when the coil component is mounted on a mounting substrate, a sufficient distance from an adjacent component can be maintained on the mounting surface side. Consequently, the flow of molding resin is unlikely to be obstructed and the filling of the molding resin between the coil component and the mounting substrate is facilitated. Therefore, the fillability of the molding resin can be improved.

Embodiments will be described in detail below with reference to the accompanying drawings. Same reference signs are given to the same or corresponding elements in the description of the drawings, and redundant description will be omitted.

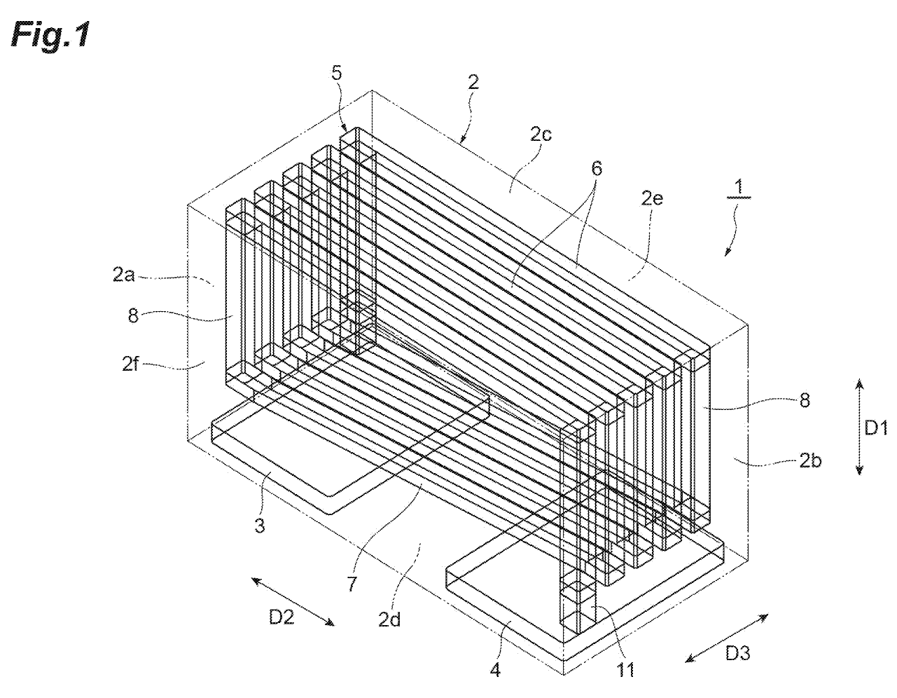

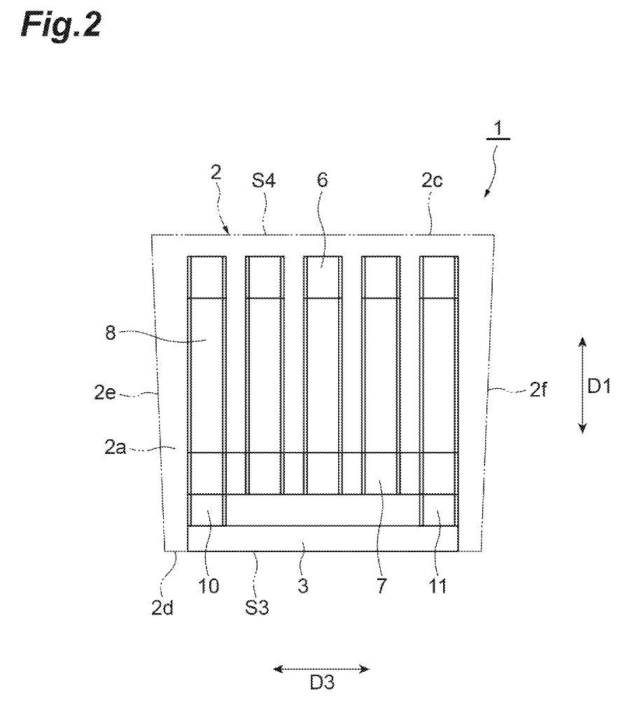

A coil component 1 according to an embodiment will be described with reference to FIGS. 1-4. As illustrated in FIGS. 1-4, the coil component 1 includes an element body 2, a terminal electrode 3, a terminal electrode 4, a coil 5, a first connecting conductor 10, and a second connecting conductor 11. The coil component 1 is, for example, a radio-frequency (RF) inductor. In FIGS. 1 and 2, the element body 2 is illustrated in two-dot chain lines to show the internal structure of the coil component 1 in a transparent manner.

The element body 2 has a hexahedral shape. The element body 2 has, as its outer surfaces, a pair of end surfaces 2a, 2b, a pair of main surfaces 2c, 2d, and a pair of side surfaces 2e, 2f. Each of the main surfaces 2c, 2d is adjacent to the end surfaces 2a, 2b and the side surfaces 2e, 2f. Each of the end surfaces 2a, 2b is adjacent to the main surfaces 2c, 2d and the side surfaces 2e, 2f. Each of the side surfaces 2e, 2f is adjacent to the main surfaces 2c, 2d and the end surfaces 2a, 2b. The hexahedral shape includes a hexahedral shape in which the corners and edges are chamfered, and a hexahedral shape in which the corners and edges are rounded.

In this embodiment, each of the end surfaces 2a, 2b, the main surfaces 2c, 2d, and the side surfaces 2e, 2f is formed of a planar surface. The corners positioned at the intersections of three adjacent surfaces of the element body 2 and the edges positioned at the intersections of two adjacent surfaces of the element body 2 may be chamfered or rounded.

The main surfaces 2c, 2d face each other in a first direction D1. The main surfaces 2c, 2d have a rectangular shape. The main surface 2d forms a mounting surface. The main surface 2d is a surface that faces, for example, a mounting substrate including other electronic devices (e.g., a circuit substrate or another coil component) not shown when the coil component 1 is mounted on the mounting substrate. The end surfaces 2a, 2b and the side surfaces 2e, 2f are surfaces that are continuous with the main surface 2d, which is the mounting surface.

Each of the end surfaces 2a, 2b and the side surfaces 2e, 2f extends so as to connect the main surface 2c and the main surface 2d. Each of the end surfaces 2a, 2b and the side surfaces 2e, 2f has a quadrangular shape. Each of the main surfaces 2c, 2d and the side surfaces 2e, 2f extends in a second direction D2 so as to connect the end surface 2a and the end surface 2b. Each of the main surfaces 2c, 2d and the end surfaces 2a, 2b extends in a third direction D3 so as to connect the side surface 2e and the side surface 2f. The first direction D1, the second direction D2, and the third direction D3 are perpendicular to each other.

The first direction D1 is a height direction of the element body 2, the second direction D2 is a length direction of the element body 2, and the third direction D3 is a width direction of the element body 2. The element body 2 has a length (length of the element body 2 in the second direction D2) greater than a height of the element body 2 (length of the element body 2 in the first direction D1) and greater than a width of the element body 2 (length of the element body 2 in the third direction D3). The height of the element body 2 may be equivalent to the width of the element body 2, less than the width of the element body 2, or greater than the width of the element body 2.

In this specification, the term “equivalent” includes minute differences, manufacturing errors, or the like within a preset range, in addition to meaning the same. For example, if a plurality of values are included in a ±2% range of an average value of the plurality of values, the plurality of values may be considered equivalent. For example, the height of the element body 2 is 200 μm. The length of the element body b is 400 μm. The width of the element body 2 is 200 μm.

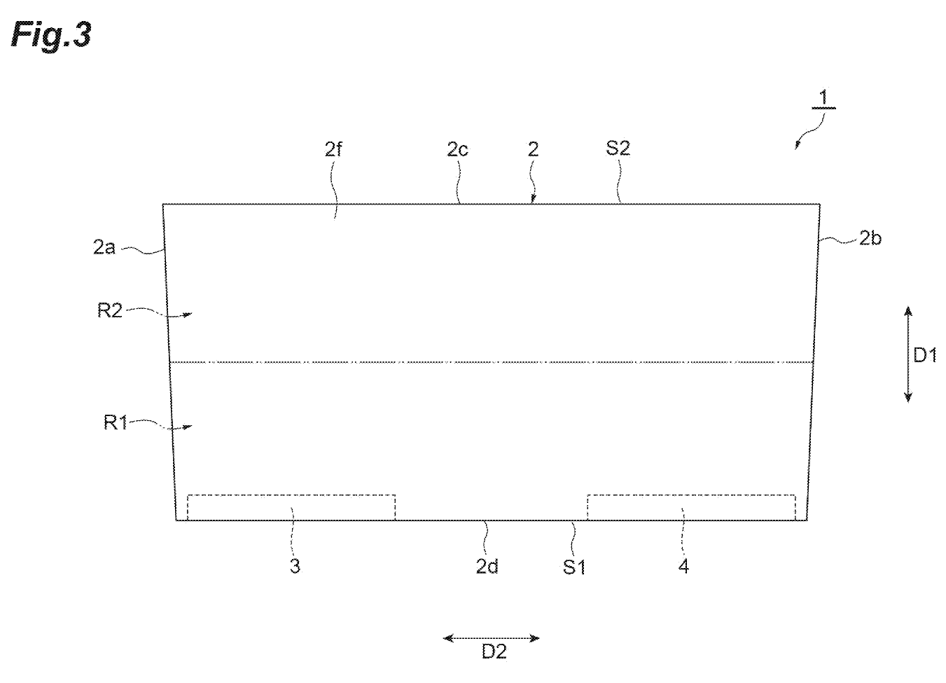

In this embodiment, as illustrated in FIGS. 2 and 3, each of the end surfaces 2a, 2b and the side surfaces 2e, 2f is inclined with respect to the first direction D1. An angle of inclination at which each of the end surfaces 2a, 2b and the side surfaces 2e, 2f is inclined with respect to the first direction D1 is 85° or more and 90° or less. The angles of inclination at which the end surfaces 2a, 2b and the side surfaces 2e, 2f are inclined with respect to the first direction D1 are, for example, equivalent. The end surfaces 2a, 2b are inclined such that the distance between the end surfaces 2a, 2b increases from the main surface 2d toward the main surface 2c. The side surfaces 2e, 2f are inclined such that the distance between the side surfaces 2e, 2f increases from the main surface 2d toward the main surface 2c.

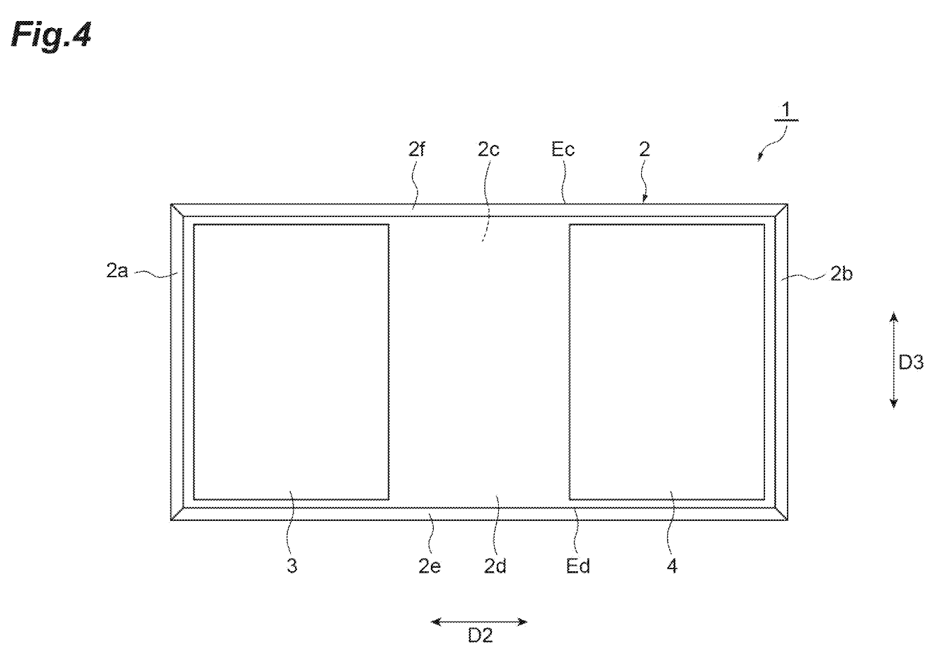

In this embodiment, the main surface 2d has an area less than an area of the main surface 2c. The area of the main surface 2d is, for example, 89% or more and less than 98% of the area of the main surface 2c. The area of the main surface 2d may, for example, be less than 96% of the area of the main surface 2c. A cross-sectional area perpendicular to the first direction D1 of the coil component 1 increases from the main surface 2d toward the main surface 2c. As illustrated in FIG. 4, an outer edge Ed of the main surface 2d is positioned inward of an outer edge Ec of the main surface 2c along the entirety of the outer edge Ed when viewed in the first direction D1. It can also be said that the entirety of the main surface 2d is positioned inward of the outer edge Ec when viewed in the first direction D1. The outer edge Ed is spaced apart from the outer edge Ec and does not include a portion in contact with the outer edge Ec when viewed in the first direction D1.

As illustrated in FIG. 3, the side surface 2f includes an edge S1 that is adjacent to the main surface 2d and an edge S2 that is adjacent to the main surface 2c. The edges S1, S2 form parts of an outer edge of the side surface 2f. The edges S1, S2 extend in the second direction D2. The edge S1 has a length in the second direction D2 less than a length of the edge S2 in the second direction D2. The difference (dimensional difference) between the length of the edge S2 in the second direction D2 and the length of the edge S1 in the second direction D2 is, for example, 3 μm or more and 15 μm or less. The side surface 2f has a trapezoidal shape. The side surface 2f has a length in the second direction D2 that increases from the main surface 2d toward the main surface 2c. Although not shown, the side surface 2e has the same shape as the side surface 2f and has the edges S1, S2 similarly to the side surface 2f.

As illustrated in FIG. 2, the end surface 2a includes an edge S3 that is adjacent to the main surface 2d and an edge S4 that is adjacent to the main surface 2c. The edges S3, S4 form parts of an outer edge of the end surface 2a. The edges S3, S4 extend in the third direction D3. The edge S3 has a length in the third direction D3 less than a length of the edge S4 in the third direction D3. The difference (dimensional difference) between the length of the edge S4 in the third direction D3 and the length of the edge S3 in the third direction D3 is, for example, 3 μm or more and 15 μm or less. The end surface 2a has a trapezoidal shape. The end surface 2a has a length in the third direction D3 that increases from the main surface 2d toward the main surface 2c. Although not shown, the end surface 2b has the same shape as the end surface 2a and has the edges S3, S4 similarly to the end surface 2a. It can be said that the coil component 1 has a width that is greater on the main surface 2c side than on the main surface 2d side when viewed in any direction perpendicular to the first direction D1.

The length of the edge S1 in the second direction D2 is the length of the main surface 2d in the second direction D2. The length of the edge S2 in the second direction D2 is the length of the main surface 2c in the second direction D2. Accordingly, the length of the main surface 2d in the second direction D2 is less than the length of the main surface 2c in the second direction D2. The length of the edge S3 in the third direction D3 is the length of the main surface 2d in the third direction D3. The length of the edge S4 in the third direction D3 is the length of the main surface 2c in the third direction D3. Accordingly, the length of the main surface 2d in the third direction D3 is less than the length of the main surface 2c in the third direction D3.

The element body 2 is formed of a plurality of insulating layers laminated in the first direction D1. That is, the lamination direction of the element body 2 is the first direction D1. In an actual element body 2, the plurality of insulating layers may be integrated such that the boundaries between the layers cannot be visually recognized, or may be integrated such that the boundaries between the layers can be visually recognized. The element body 2 has a relative permittivity of, for example, 3.3.

The insulating layers are non-magnetic resin layers and do not include a magnetic material. The material of the insulating layers includes, for example, at least one selected from a liquid crystal polymer, a polyimide resin, crystalline polystyrene, an epoxy-based resin, an acrylic-based resin, a bismaleimide-based resin, and a fluorine-based resin. The insulating layers may include a filler made of a non-magnetic material. Examples of the non-magnetic material include inorganic materials such as silica (SiO₂) and alumina (Al₂O₃). The non-magnetic material includes a glass-ceramic material or a dielectric material.

Each of the side surfaces 2e, 2f has a surface roughness greater than a surface roughness of the main surfaces 2c, 2d and greater than a surface roughness of the end surfaces 2a, 2b. The surface roughness is, for example, an arithmetic mean height Sa of a surface. The arithmetic mean height Sa of a surface is a parameter obtained by extending an arithmetic mean height Ra of a line into three dimensions. The arithmetic mean height Sa of a surface is expressed as an average of the absolute values of the heights of respective points with respect to a mean plane of a surface shape measured three-dimensionally. The side surfaces 2e, 2f have equivalent surface roughness. The surface roughness of each of the side surfaces 2e, 2f is, for example, 0.15 μm or more and 2.0 μm or less. The surface roughness of each of the side surfaces 2e, 2f may be 0.5 μm or more, or 1.0 μm or more.

As illustrated in FIG. 3, the side surface 2f has a side surface region R1 that includes the edge S1 and a side surface region R2 that includes the edge S2. The side surface region R1 is a region adjacent to the main surface 2d. The side surface region R1 is a region from the center of the side surface 2f in the first direction D1 to the main surface 2d. The side surface region R2 is a region adjacent to the main surface 2c. The side surface region R2 is a region from the center of the side surface 2f in the first direction D1 to the main surface 2c. The side surface regions R1, R2 are adjacent to each other in the first direction D1. Although not shown, the side surface 2e has the side surface regions R1, R2 similarly to the side surface 2f.

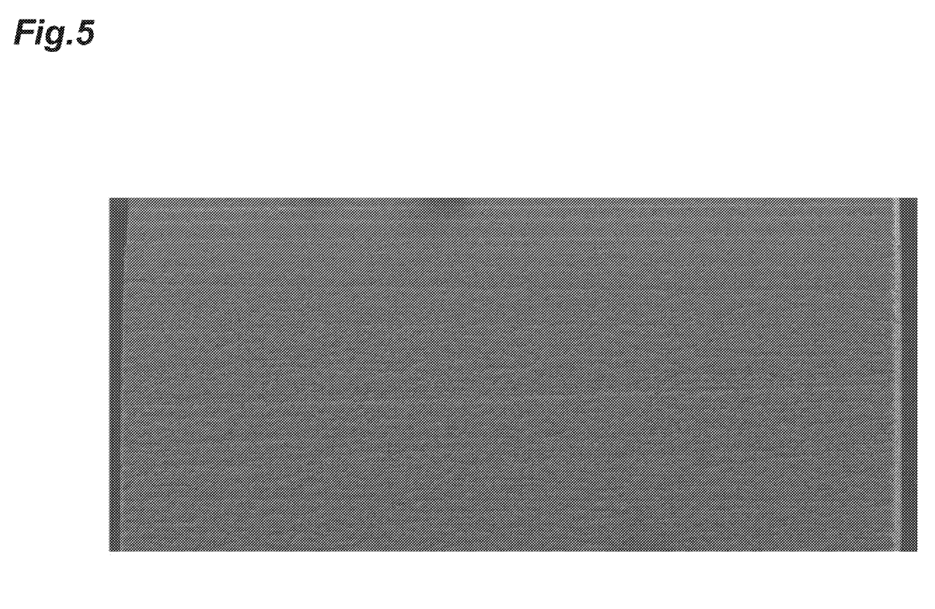

Each of the side surfaces 2e, 2f is provided with a plurality of streak-like grooves extending in the second direction D2 (see FIG. 5). In this embodiment, a greater number of these grooves are provided in the side surface region R1 than in the side surface region R2. The density of the grooves in the side surface region R1 is higher than the density of the grooves in the side surface region R2. The depth of the grooves in the side surface region R1 is greater than the depth of the grooves in the side surface region R2. The surface roughness of the side surface region R1 is greater than the surface roughness of the side surface region R2. FIG. 5 shows a surface of a side surface corresponding to the side surface 2e or the side surface 2f of a coil component according to an example. In this example, the insulating layers forming the element body is formed of an epoxy resin to which a silica filler is added.

The surface roughness of the main surface 2c is greater than the surface roughness of the main surface 2d. The surface roughness of the main surface 2c is, for example, 0.16 μm. The surface roughness of the main surface 2d is, for example, 0.12 μm. The end surfaces 2a, 2b have equivalent surface roughness. The surface roughness of each of the end surfaces 2a, 2b is, for example, 0.16 μm or more and 0.5 μm or less.

As illustrated in FIGS. 1 and 2, the terminal electrodes 3, 4 are connected to the coil 5. The terminal electrodes 3, 4 are provided in the element body 2. The terminal electrodes 3, 4 are disposed on the main surface 2d of the element body 2. The terminal electrodes 3, 4 are provided in the element body 2 spaced apart from each other in the second direction D2. Specifically, the terminal electrode 3 is disposed on the end surface 2a side of the element body 2. The terminal electrode 4 is disposed on the end surface 2b side of the element body 2. The terminal electrodes 3, 4 are spaced apart from the main surface 2c, the end surfaces 2a, 2b, and the side surfaces 2e, 2f. The terminal electrodes 3, 4 are embedded in the element body 2 and are exposed only from the main surface 2d.

As illustrated in FIG. 4, the terminal electrodes 3, 4 may, for example, have a rectangular shape when viewed in the first direction D1. The terminal electrodes 3, 4 are disposed such that each side extends along the second direction D2 or the third direction D3. As illustrated in FIGS. 2 and 3, the terminal electrodes 3, 4 do not protrude from the main surface 2d. That is, in this embodiment, the surfaces of the terminal electrodes 3, 4 are flush with the main surface 2d. The terminal electrodes 3, 4 are formed of a conductive material (e.g., Cu).

The terminal electrodes 3, 4 may be provided with a plating layer (not shown) including, for example, Ni, Sn, or Au by being subjected to electrolytic plating or electroless plating. The plating layer may include, for example, a Ni plating film including Ni and covering the terminal electrodes 3, 4 and an Au plating film including Au and covering the Ni plating film.

As illustrated in FIGS. 1 and 2, the coil 5 is disposed inside the element body 2. The coil 5 has a plurality of first wiring portions 6, a plurality of second wiring portions 7, and a plurality of pillar portions 8. The coil 5 is formed by the first wiring portions 6, the second wiring portions 7, and the pillar portions 8 being electrically connected. A coil axis of the coil 5 is provided along the third direction D3. The first wiring portions 6, the second wiring portions 7, and the pillar portions 8 are formed of a conductive material (e.g., Cu). The first wiring portions 6, the second wiring portions 7, and the pillar portions 8 are disposed spaced apart from the end surfaces 2a, 2b, the main surfaces 2c, 2d, and the side surfaces 2e, 2f.

Each of the first wiring portions 6 is disposed on the main surface 2c side of the element body 2. Each of the first wiring portions 6 extends along the second direction D2. Each of the first wiring portions 6 connects two pillar portions 8. The first wiring portion 6 spans between two pillar portions 8. One end of each of the first wiring portions 6 in the direction of extension (end portion on the end surface 2a side) is connected to one end of a corresponding pillar portion 8 (end portion on the main surface 2c side). The other end of each of the first wiring portions 6 in the direction of extension (end portion on the end surface 2b side) is connected to one end of the other corresponding pillar portion 8 (end portion on the main surface 2c side).

Each of the second wiring portions 7 is disposed on the main surface 2d (mounting surface) side of the element body 2. Each of the second wiring portions 7 extends substantially in the second direction D2. The direction of extension of the second wiring portions 7 is a direction perpendicular to the first direction D1 and the third direction D3 and slightly inclined with respect to the second direction D2. Each of the second wiring portions 7 connects two pillar portions 8. The second wiring portion 7 spans between two pillar portions 8. One end of each of the second wiring portions 7 in the direction of extension (end portion on the end surface 2a side) is connected to the other end of a corresponding pillar portion 8 (end portion on the main surface 2d side). The other end of each of the second wiring portions 7 in the direction of extension (end portion on the end surface 2b side) is connected to the other end of the other corresponding pillar portion 8 (end portion on the main surface 2d side). The number of the second wiring portions 7 is one less than that of the first wiring portions 6. That is, when there are n first wiring portions 6, there are n-1 second wiring portions 7.

Each of the pillar portions 8 extends along the first direction D1. The pillar portion 8 connects the first wiring portion 6 and the second wiring portion 7. In this embodiment, the pillar portion 8 has a prismatic shape. The pillar portion 8 has a cross-sectional shape (direction perpendicular to the first direction D1) that is rectangular. One end of the pillar portion 8 is connected to an end portion of the first wiring portion 6. The other end of the pillar portion 8 is connected to an end portion of the second wiring portion 7.

The first connecting conductor 10 connects the terminal electrode 3 and one end portion of the coil 5. The first connecting conductor 10 is connected to the other end of the pillar portion 8 of the coil 5. The first connecting conductor 10 is disposed at a position closer to the end surface 2a and closer to the side surface 2e. The first connecting conductor 10 is composed of a conductive material. The first connecting conductor 10 is formed, for example, of Cu.

The second connecting conductor 11 connects the terminal electrode 4 and the other end portion of the coil 5. The second connecting conductor 11 is connected to the other end of the pillar portion 8 of the coil 5. The second connecting conductor 11 is disposed at a position closer to the end surface 2b and closer to the side surface 2f. The second connecting conductor 11 is composed of a conductive material. The second connecting conductor 11 is formed, for example, of Cu.

The coil component 1 can be manufactured as follows. The element body 2 is formed by laminating insulating layers formed from non-magnetic resin layers by a so-called thin-film method. After forming conductor portions to be the first wiring portions 6 on an insulating layer constituting the main surface 2c, an insulating layer is formed around the conductor portions. The conductor portions are formed by plating after seed layers are formed. The forming of the conductor portions and the insulating layer is repeated, and finally the conductor portions to be the terminal electrodes 3, 4 and an insulating layer constituting the main surface 2d are formed, after which the top surface is planarized by polishing. A plurality of individual coil components 1 (see FIG. 1) are obtained by dicing using a blade.

The end surfaces 2a, 2b and the side surfaces 2e, 2f are diced surfaces resulting from dicing. The above-described streak-like grooves formed on the side surfaces 2e, 2f are dicing marks. The surface shape of the end surfaces 2a, 2b and the side surfaces 2e, 2f can be set by adjusting dicing conditions such as the shape of the blade or the dicing speed. Streak-like grooves extending in the third direction D3 can be provided on the end surfaces 2a, 2b by adjusting the dicing conditions.

The angle of inclination at which each of the end surfaces 2a, 2b and the side surfaces 2e, 2f is inclined with respect to the first direction D1 can be set, for example, by adjusting the shape of the blade. The main surface 2c is a backgrinded surface formed by backgrinding. The main surface 2d is a polished surface formed by polishing during planarization. The above-described relationships among the surface roughnesses of the respective surfaces are achieved by adjusting the dicing conditions of the end surfaces 2a, 2b and the side surfaces 2e, 2f, the backgrinding conditions of the main surface 2c, and the polishing conditions of the main surface 2d.

As described above, in the coil component 1, the area of the main surface 2d forming the mounting surface is less than the area of the main surface 2c. Accordingly, when the coil component 1 is mounted on a mounting substrate, a sufficient distance from an adjacent component can be maintained on the mounting surface side. Consequently, the flow of molding resin is unlikely to be obstructed and the filling of the molding resin between the coil component 1 and the mounting substrate is facilitated. Therefore, the fillability of the molding resin can be improved. The main surface 2c is a suction surface held by a suction pad when disposing the coil component 1 on the mounting substrate. Since the main surface 2c has a large area, the suction performance can be improved.

The outer edge Ed of the main surface 2d is positioned inward of the outer edge Ec of the main surface 2c when viewed in the first direction D1. Accordingly, in the coil component 1, regardless of the direction in which an adjacent component is disposed perpendicular to the first direction D1, a sufficient distance from the adjacent component can be maintained on the mounting surface side. Therefore, the fillability of the molding resin can be reliably improved.

The terminal electrodes 3, 4 are disposed on the main surface 2d. Accordingly, a gap is formed between portions of the main surface 2d on which the terminal electrodes 3, 4 are not disposed and the mounting substrate in a state where the coil component 1 is disposed on the mounting substrate. In order to fill the molding resin in this gap, a configuration in which the flow of the molding resin is unlikely to be obstructed is advantageous.

The side surfaces 2e, 2f are provided with the plurality of streak-like grooves extending in the second direction D2. This facilitates the flow of the molding resin along the grooves in the second direction D2.

The area of the main surface 2d is 89% or more and less than 98% of the area of the main surface 2c. By being 89% or more, the coil 5 can be covered by the element body 2. By being less than 98%, the flow of the molding resin is unlikely to be obstructed.

Since the element body 2 of the coil component 1 is made of resin, it is easily charged and is light. Accordingly, when mounting the coil component 1, the element body 2 may become charged and adhere electrostatically to adjacent components, which may cause mounting defects. The end surfaces 2a, 2b and the side surfaces 2e, 2f are surfaces facing the adjacent components when the coil component 1 is mounted. In particular, since the side surfaces 2e, 2f have greater areas than the end surfaces 2a, 2b, they are more likely to adhere electrostatically to the adjacent components. In the coil component 1, the surface roughness of the side surfaces 2e, 2f is greater than the surface roughness of the main surface 2d. Since the surface roughness of the side surfaces 2e, 2f is large, the side surfaces 2e, 2f are unlikely to become charged. Accordingly, as a result of suppression of electrostatic adhesion to the adjacent components, the mounting defects of the coil component 1 are suppressed. Since the surface roughness of the main surface 2d, which is the mounting surface, is small, the molding resin for resin sealing can be easily filled between the main surface 2d and the mounting substrate after the coil component 1 is mounted.

The terminal electrodes 3, 4 are disposed only on the main surface 2d. Since the terminal electrodes 3, 4 are conductors, charging can be suppressed on the main surface 2d. However, since the main surface 2c, the side surfaces 2e, 2f, and the end surfaces 2a, 2b are not provided with the terminal electrodes 3, 4, they are easily charged. That is, electrostatic adhesion is more likely to occur in the coil component 1 than in a configuration in which the terminal electrodes 3, 4 are disposed on the main surface 2c, the side surfaces 2e, 2f, and the end surfaces 2a, 2b. Accordingly, it is more effective to increase the surface roughness of the side surfaces 2e, 2f to suppress electrostatic adhesion.

Since the surface roughness of the end surfaces 2a, 2b is greater than the surface roughness of the main surface 2d, the end surfaces 2a, 2b are unlikely to become charged. Accordingly, as a result of further suppression of electrostatic adhesion between the coil component 1 and the adjacent components, the mounting defects of the coil component 1 are further suppressed.

The surface roughness of the side surfaces 2e, 2f is greater than the surface roughness of the end surfaces 2a, 2b and greater than the surface roughness of the main surface 2c. Since the surface roughness of the side surfaces 2e, 2f is the greatest among the outer surfaces of the element body 2, electrostatic adhesion can be more effectively suppressed. The main surface 2c is a suction surface held by a suction pad when disposing the coil component 1 on the mounting substrate. Since the main surface 2c has a small surface roughness, the suction performance can be improved.

Since the surface roughness of the side surfaces 2e, 2f is 0.15 μm or more, charging of the side surfaces 2e, 2f can be suppressed. Since the surface roughness of the side surfaces 2e, 2f is 2.0 μm or less, the detachment of the filler included in the element body 2 from the side surfaces 2e, 2f can be suppressed.

The length of the main surface 2d in the third direction D3 is less than the length of the main surface 2c in the third direction D3. Accordingly, the distance between an adjacent component and the side surface region R1 tends to be greater than the distance between the adjacent component and the side surface region R2 when the coil component 1 is mounted. The surface roughness of the side surface region R1 is greater than the surface roughness of the side surface region R2. Accordingly, the adhesion strength between the molding resin and the coil component 1 can be increased in the side surface region R1 at which the distance from the adjacent component tends to be greater.

Since the plurality of streak-like grooves extending in the second direction D2 are provided on the side surfaces 2e, 2f, the surface roughness of the side surfaces 2e, 2f can be increased. These grooves can be easily formed by adjusting the dicing conditions.

Although the embodiments have been described above, the present invention is not necessarily limited to these embodiments, and various modifications are possible without departing from the gist thereof.

In the above embodiments, an example in which the terminal electrodes 3, 4 do not protrude from the main surface 2d has been described. That is, an example in which the surfaces of the terminal electrodes 3, 4 are flush with the main surface 2d has been described. However, the terminal electrodes 3, 4 may protrude from the main surface 2d.

In the above embodiments, an example in which each of the end surfaces 2a, 2b and the side surfaces 2e, 2f is inclined with respect to the first direction D1 has been described. However, it is only required that at least one of the end surfaces 2a, 2b and the side surfaces 2e, 2f is inclined with respect to the first direction D1. In a case where the end surfaces 2a, 2b are parallel to the first direction D1, the end surfaces 2a, 2b face each other in the second direction D2. In a case where the side surfaces 2e, 2f are parallel to the first direction D1, the side surfaces 2e, 2f face each other in the third direction D3. The outer edge Ed of the main surface 2d may include a portion in contact with the outer edge Ec or may include a portion positioned outward of the outer edge Ec when viewed in the first direction D1. The end surfaces 2a, 2b and the side surfaces 2e, 2f may include a curved surface.

In the above embodiments, the surface roughness of the end surfaces 2a, 2b is less than the surface roughness of the side surfaces 2e, 2f, but it may be equivalent to the surface roughness of the side surfaces 2e, 2f or may be greater than the surface roughness of the side surfaces 2e, 2f. The surface roughness of the side surfaces 2e, 2f may be equivalent to the surface roughness of the main surface 2d or may be less than the surface roughness of the main surface 2d.

In the above embodiments, the terminal electrodes 3, 4 are disposed only on the main surface 2d, but they may be disposed on other surfaces of the element body 2. For example, the terminal electrode 3 may be disposed on the main surface 2d and the end surface 2a and may be L-shaped when viewed in the third direction D3. The terminal electrode 4 may be disposed on the main surface 2d and the end surface 2b and may be L-shaped when viewed in the third direction D3.

The embodiments and variations described above may be combined as appropriate. As is understood from the embodiments and variations described above, this specification includes the disclosure of the aspects shown below.

What is claimed is:

1. A coil component comprising:
an element body formed by laminating insulating layers;
a coil disposed inside the element body; and
a terminal electrode connected to the coil,
wherein the element body includes a first main surface forming a mounting surface, a second main surface facing the first main surface in a first direction, a pair of side surfaces adjacent to the first main surface and the second main surface and extending in a second direction perpendicular to the first direction, and a pair of end surfaces adjacent to the first main surface and the second main surface and extending in a third direction perpendicular to the first direction, and
wherein the first main surface has an area less than an area of the second main surface.

2. The coil component according to claim 1,
wherein an outer edge of the first main surface is positioned inward of an outer edge of the second main surface when viewed in the first direction.

3. The coil component according to claim 1,
wherein the terminal electrode is disposed on the first main surface.

4. The coil component according to claim 1,
wherein the pair of side surfaces is provided with a plurality of streak-like grooves extending in the second direction.

5. The coil component according to claim 1,
wherein the area of the first main surface is 89% or more and less than 98% of the area of the second main surface.

6. The coil component according to claim 1,
wherein the pair of side surfaces are inclined with respect to the first direction such that a distance between the pair of side surfaces increases from the first main surface toward the second main surface.

7. The coil component according to claim 6,
wherein an angle of inclination at which the pair of side surfaces are inclined with respect to the first direction is 85° or more and 90° or less.

8. The coil component according to claim 1,
wherein the pair of end surfaces are inclined with respect to the first direction such that a distance between the pair of end surfaces increases from the first main surface toward the second main surface.

9. The coil component according to claim 8,
wherein an angle of inclination at which the pair of end surfaces are inclined with respect to the first direction is 85° or more and 90° or less.

10. The coil component according to claim 1,
wherein a surface roughness of the pair of side surfaces is greater than a surface roughness of the first main surface.

11. The coil component according to claim 1,
wherein a surface roughness of the pair of side surfaces is greater than a surface roughness of the pair of end surfaces.

12. The coil component according to claim 1,
wherein a surface roughness of the pair of side surfaces is 0.15 μm or more and 2.0 μm or less.

13. The coil component according to claim 1,
wherein a surface roughness of the pair of end surfaces is greater than a surface roughness of the first main surface.

14. The coil component according to claim 1,
wherein a surface roughness of the second main surface is greater than a surface roughness of the first main surface.

15. The coil component according to claim 1,
wherein a surface of the terminal electrode is flush with the first main surface.

16. The coil component according to claim 1,
wherein the terminal electrode is embedded in the element body and is exposed only from the first main surface.

17. The coil component according to claim 1,
wherein the insulating layers are non-magnetic resin layers and do not include a magnetic material.

18. The coil component according to claim 17,
wherein a material of the insulating layers includes at least one selected from a liquid crystal polymer, a polyimide resin, crystalline polystyrene, an epoxy-based resin, an acrylic-based resin, a bismaleimide-based resin, and a fluorine-based resin.

19. The coil component according to claim 1,
wherein a coil axis of the coil is provided along the third direction.

20. A coil component comprising:
an element body formed by laminating insulating layers, wherein the element body includes a first main surface forming a mounting surface, a second main surface facing the first main surface in a first direction, a pair of side surfaces adjacent to the first main surface and the second main surface and extending in a second direction perpendicular to the first direction, and a pair of end surfaces adjacent to the first main surface and the second main surface and extending in a third direction perpendicular to the first direction;
a coil disposed inside the element body; and
a pair of terminal electrodes connected to the coil and disposed on the first main surface,
wherein the area of the first main surface is 89% or more and less than 98% of the area of the second main surface, and
wherein the pair of side surfaces is provided with a plurality of streak-likegrooves extending in the second direction.
